(19) United States
(12) Patent Application Publication
(10) Pub. No.: US 2020/0203977 A1
(43) Pub. Date: Jun. 25, 2020

(54) MULTIPLE OUTLET CHARGING NETWORK FOR AT-THE-SEAT CHARGING OF DEVICES WHILE SEATED IN A CONFERENCE MEETING

(71) Applicant: Matthew Victor A'Hearn, Basalt, CO (US)

(72) Inventor: Matthew Victor A'Hearn, Basalt, CO (US)

(21) Appl. No.: 16/225,731

(22) Filed: Dec. 19, 2018

(51) Int. Cl. H02J 7/00

(52) U.S. Cl. CPC H02J 7/0052; H02J 2007/006; H02J 2007/0062; H02J 7/0026

(57) ABSTRACT

An outlet charging network system for at-the-seat charging of devices while seated in a conference meeting is provided. The present invention embodies the method of installing a temporary, re-useable network of power access points giving conference attendees device charging access at their seats. A charging connection is installed at the base of each row of conference chairs, or along each row of tables in a classroom set-up. wherein a plurality of double USB ports is spaced apart along the charging connection so that each double USB ports are adjacent to and between a pair of the conference chairs, allowing each attendee to plug in their USB charging cords to at least one USB port per chair.

### BACKGROUND OF THE INVENTION

The present invention relates to power networks and, more particularly, to an outlet charging network system for at-the-seat charging of devices while seated in a conference meeting.

Conference attendees spend most of their time seated in a meeting room. An attendee's biggest complaint is the lack of access to power for charging devices (smart phones, tablets, etc.) while seated at conferences meetings, general sessions, breakout meetings, or the like.

As can be seen, there is a need for an outlet charging network system for at-the-seat charging of devices while seated in a conference meeting. The present invention embodies the method of installing a temporary, re-useable network of power access points giving conference attendees device charging access at their seats.

### SUMMARY OF THE INVENTION

In one aspect of the present invention, an outlet charging network system for at-the-seat charging of devices while seated in a conference meeting, including a plurality of rows of chairs; a network connection extending along each row; a plurality of charging devices spaced apart along each network connection; each charging device providing two or more USB ports; and each charging device disposed between two adjacent chairs of each row of chairs. Alternatively, the outlet charging network system may be placed at every other place on spaced apart tables in a “classroom style” set-up.

In another aspect of the present invention, the outlet charging network system for at-the-seat charging of devices while seated in a conference meeting includes a plurality of rows of chairs and rows of tables; an AC plug electrically coupling each network connection and a standard AC electrical outlet (with enough current or power to accommodate the number of USB ports in the rows); a network connection extending along each row, wherein each network connection comprises a fire-code approved cable; a power converter operatively associated to each network connection, each power converter configured to convert standard AC power to lower voltage DC current; a plurality of charging devices spaced apart along each network connection; each charging device providing two or more USB ports, wherein each charging device provides an indicator light serially connected to each USB port; each charging device disposed between two adjacent chairs of each row of chairs; and a low voltage connector electrically connected each charging device to an operatively associated network connection, wherein each low voltage connector includes an operatively associated DC jack, DC plug and DC cable.

These and other features, aspects and advantages of the present invention will become better understood with reference to the following drawings, description and claims.

### BRIEF DESCRIPTION OF THE DRAWINGS

FIG. 1 is a top plan view of an exemplary embodiment of the present invention, shown set up in a “theatre style”;

FIG. 2 is a detailed perspective view of an exemplary embodiment of the present invention; and

FIG. 3 is a top plan view of an exemplary embodiment of the present invention, shown set up in a “classroom style”.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an outlet charging network system for at-the-seat charging of devices while seated in a conference meeting. The present invention embodies the method of installing a temporary, re-useable network of power access points giving conference attendees device charging access at their seats. A charging connection is installed at the base of each row of conference chairs, wherein a plurality of double USB ports is spaced apart along the charging connection so that each double USB ports are adjacent to and between a pair of the conference chairs, allowing each attendee to plug in their USB charging cords to at least one USB port per chair.

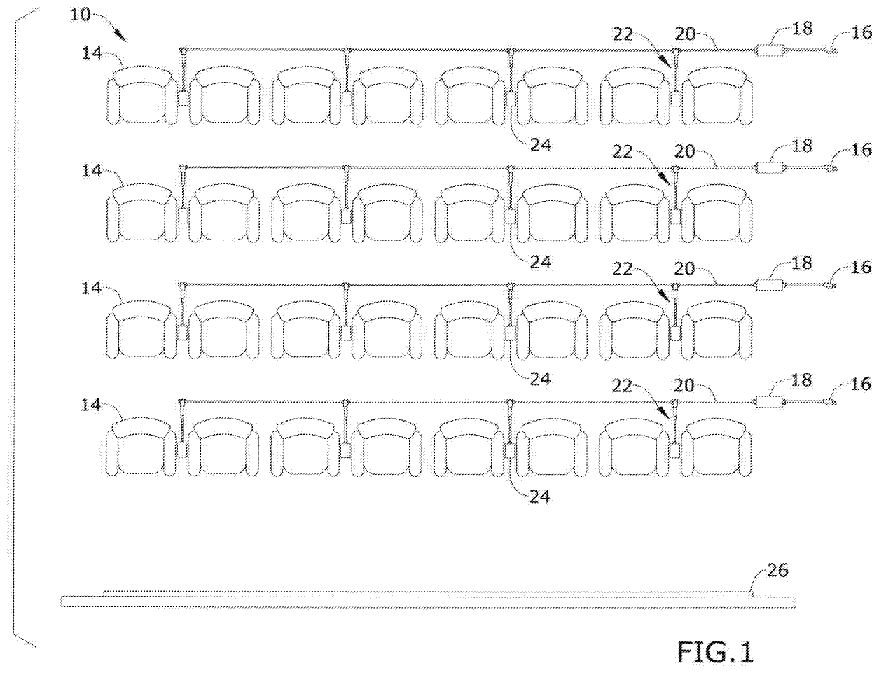

Referring to FIGS. 1 through 3, the present invention may include an outlet charging network system 10 for at-the-seat charging of devices while seated in a conference meeting hall 26.

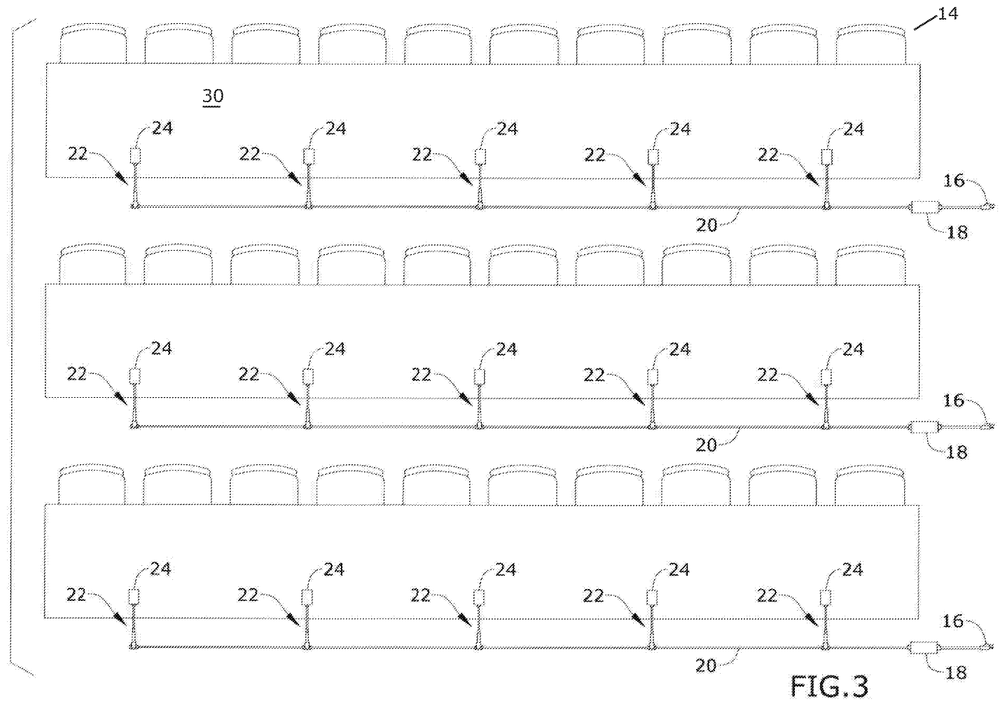

Typically, conference meeting halls 26 provide an arrangement of seats 14 in a “theater style” layout (as illustrated in FIG. 1) as well as “classroom style” layout (as illustrated in FIG. 3), or as required by local fire code or venue guidelines. In the theatre layout a result, rows of seats 14 are provided in such a space. In the classroom layout, each row of seats 14 are associated with a table 30.

In either layout, each row extends from a first end to an opposing second end. On one end of each row may be an AC plug 16 (plugged into any standard AC electrical outlet) electrically coupled to a power converter 18 adapted to convert standard AC power to lower voltage DC current. Each power converter 18 is electrically associated with a network connection 20 (such as a fire code approved cable) that extends to near or adjacent to the opposing end of said row. Spaced apart along the network connection 20 may be a plurality of low voltage connections 22, each low voltage connections coupled to a plurality of USB ports 24. In certain embodiments, the plurality of USB ports 24 would be a double USB port device. Each plurality of USB ports 24 and so low voltage connection 22 may be associated with a pair of chairs 14 so that a user seated on one of the pair of chairs 14 can electrically connect through one of the plurality of USB ports 24. In certain embodiments, the plurality of USB ports 24 is disposed between each pair of chairs 14. It is to be understood that the dimensions/lengths of the various connections (20, 22, etc.) may vary depending on the applicability to the specific setting. For example, the network connection could range between two feet in length or twenty feet or more in length.

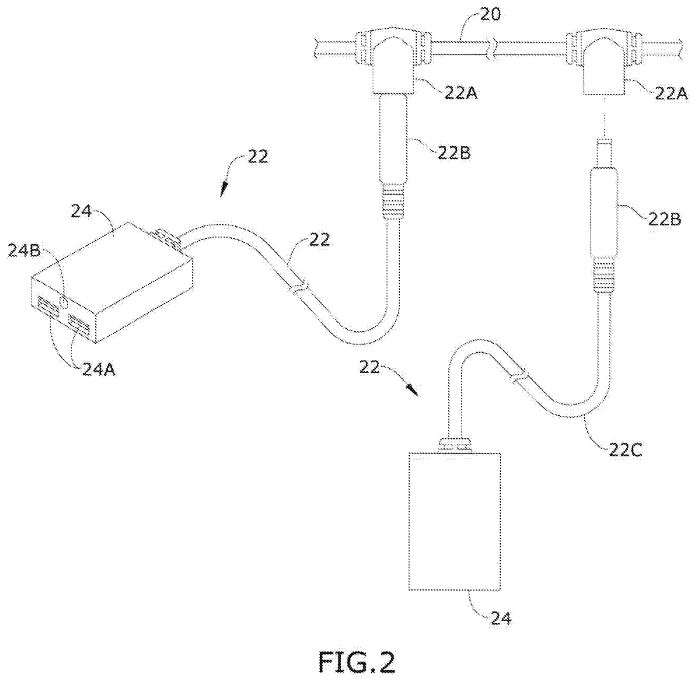

Referring to FIG. 2, each lower voltage connection 22 may include a DC jack 22a, electrically coupled to a DC plug 22b, electrically coupled to a DC cable 22c, which in turn electrically connect to one or the plurality of USB ports 24. Each plurality of USB ports 24 may be a female socket 24a. Each plurality of USB ports 24 may provide a charging indicator 24b that indicates an electrical connection has been formed through at least one of the female sockets 24 by a user.

A method of using the present invention may include the following. The charging network system 10 disclosed above may be provided. An installer may assemble the AC plug 16, power converter 18, network connection 20 and plurality of USB ports 24 at proper intervals for associated with substantially all of the chairs 14 of the conference hall 26. To use the present invention a user simply needs to plug in a USB charging cord of a phone or tablet into a female socket 24a of the charging network system 10.

It should be understood, of course, that the foregoing relates to exemplary embodiments of the invention and that modifications may be made without departing from the spirit and scope of the invention as set forth in the following claims.

What is claimed is:

1. An outlet charging network system for at-the-seat charging of devices while seated in a conference meeting, comprising:
a plurality of rows of chairs or rows of tables;
a network connection extending along each row;
a plurality of charging devices spaced apart along each network connection;
each charging device providing two or more USB ports; and
each charging device disposed between two adjacent chairs of each row of chairs or row of tables.

2. The outlet charging network system of claim 1, wherein each network connection comprises a fire-code approved cable.

3. The outlet charging network system of claim 1, further comprising a power converter operatively associated to each network connection, each power converter configured to convert standard AC power to lower voltage DC current.

4. The outlet charging network system of claim 1, further comprising an AC plug electrically coupling each network connection and a standard AC electrical outlet.

5. The outlet charging network system of claim 1, wherein each charging device provides an indicator light serially connected to each USB port.

6. The outlet charging network system of claim 1, further comprising a low voltage connector electrically connected each charging device to an operatively associated network connection.

7. The outlet charging network system of claim 6, wherein each low voltage connector includes an operatively associated DC jack, DC plug and DC cable.

8. An outlet charging network system for at-the-seat charging of devices while seated in a conference meeting, comprising:
a plurality of rows of chairs or tables;
an AC plug electrically coupling each network connection and a standard AC electrical outlet;
a network connection extending along each row, wherein each network connection comprises a fire-code approved cable;
a power converter operatively associated to each network connection, each power converter configured to convert standard AC power to lower voltage DC current;
a plurality of charging devices spaced apart along each network connection;
each charging device providing two or more USB ports, wherein each charging device provides an indicator light serially connected to each USB port;
each charging device disposed between two adjacent chairs of each row of chairs or tables; and
a low voltage connector electrically connected each charging device to an operatively associated network connection, wherein each low voltage connector includes an operatively associated DC jack, DC plug and DC cable.

9. A method for providing at-the-seat charging capabilities for each seat in a conference meeting, comprising the step of:
providing the system of claim 8 based in part on whether the conference meeting embodies a classroom style layout or a theatre style layout.
